(19) United States
(12) Patent Application Publication
(10) Pub. No.: US 2015/0074203 A1
(43) Pub. Date: Mar. 12, 2015

(54) PERSONALISED DYNAMIC EMAIL ADDRESSES IN ENTERPRISE ENVIRONMENTS

(71) Applicants: FRANK EICHINGER, Karlsruhe (DE); Christoph Eichhorn, Freiburg im Breisgau (DE); Nina Oertel, Mannheim (DE); Tom Kiemes, Karlsruhe (DE)

(72) Inventors: FRANK EICHINGER, Karlsruhe (DE); Christoph Eichhorn, Freiburg im Breisgau (DE); Nina Oertel, Mannheim (DE); Tom Kiemes, Karlsruhe (DE)

(21) Appl. No.: 14/024,613

(22) Filed: Sep. 11, 2013

(51) Int. Cl. H04L 12/58

(52) U.S. Cl. CPC H04L 51/22
USPC 709/206

(57) ABSTRACT

Companies provide a set of default personalized dynamic email addresses for both individuals and groups. The embodiments may be implemented as an extension to existing email servers, which are coupled to an existing enterprise information system. When receiving an email sent to a personalized dynamic email address, an address resolver component is used to access the definition of the email address, query for the respective recipient(s), and replace the recipient(s) in the email message. Users have the possibility to define further personalized dynamic email addresses using, for example, a web interface. The embodiments may be smoothly integrated into an existing communication infrastructure of companies without the need to change existing systems.

### BACKGROUND

Email is an important means for communication within companies. While messages are frequently sent to people who know each other personally, many emails are intended to be received by a person having a specific role in a company. Examples include a direct manager, an HR business partner and a team assistant (who might change on a daily basis if the assistants are working part-time or are on sick leave, for instance). The names of the persons filling these roles are not always known and need to be looked up in some system or by asking other colleagues. Furthermore, the people executing these roles might change frequently and employees might not be informed about this.

Besides messages between two individuals, emails are frequently sent to distribution lists. Distribution lists exist in many companies, for instance, for all people in a certain team, at a certain location, of a certain cost center etc. However, these lists are typically static in nature. They need to be maintained manually, which is error-prone, or they are being generated automatically from data stored in some systems. The latter typically happens on a periodic basis and might therefore not reflect recent changes.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating solution architecture for personalized dynamic email addresses in enterprise environments.

FIG. 2 is a flow diagram illustrating an embodiment of a method for personalized dynamic email addresses in enterprise environments.

FIG. 3 is a block diagram illustrating a management system for personalized dynamic email addresses in enterprise environments.

FIG. 4 is a block diagram illustrating an embodiment of a computing environment in which the techniques described for personalized dynamic email addresses in enterprise environments can be implemented.

### DETAILED DESCRIPTION

Embodiments of techniques for personalized dynamic email addresses in enterprise environments are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

A personalized dynamic email address is an email address that does not initially define an exact person as a receiver but rather defines a receiver or a group of receivers that are in a specific relation to the sender. One example could be the address “my(manager)@company.corp”, which delivers an email to the current manager of the sender of the email. If an employee wants, for example, to inform the current manager that she or he will stay at home because of sickness, the employee can send an email to the address mentioned, and the system delivers this mail to the correct manager, even if reorganizations are ongoing and the employee does not know the name of her or his current manager. This makes it also unnecessary to look up this information in a corporate address book, if available.

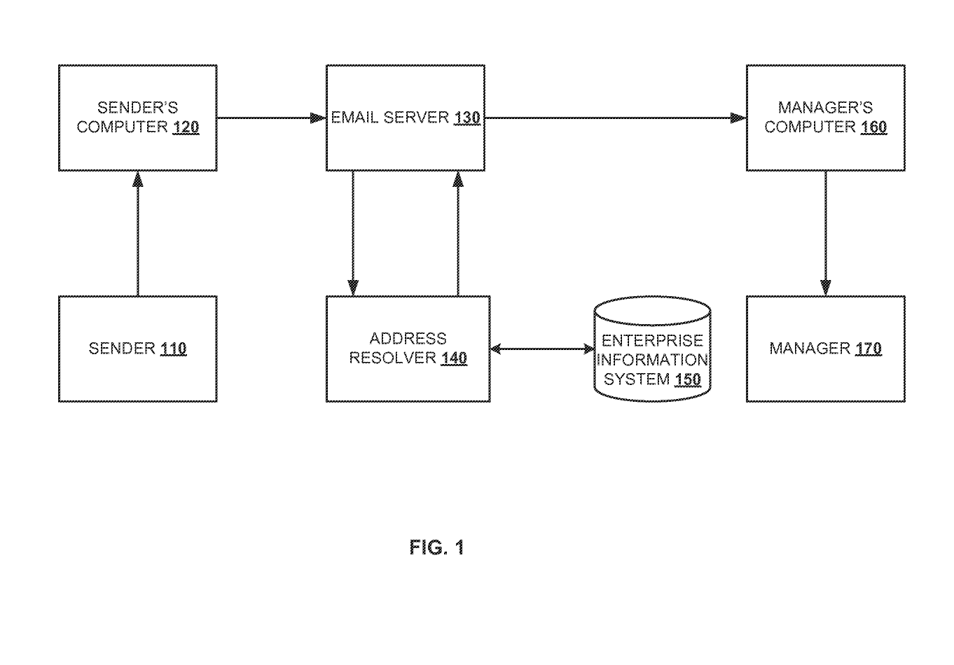

FIG. 1 is a block diagram illustrating solution architecture for personalized dynamic email addresses in enterprise environments. A sender 110 sends an email message from his computer 120 to his manager 170. The sender 110 uses a standard mail client and in the “To” field, the sender 110 uses “my(manager)@company.corp”. The sender 110 email address may be, for example, “frank@company.corp”.

The sender's computer 120 delivers the message to a default email server 130 using proprietary or standard protocols, such as Simple Mail Transfer Protocol (SMTP). The email server 130 then delivers the message to an address resolver 140 using either pull or push mechanisms, because the address resolver 140 has the email address “my@company.corp”. The email server 130 uses proprietary or standard protocols, such as SMTP, to deliver the message to the address resolver 140.

The address resolver 140 resolves the alias “manager” enclosed as a comment in the parentheses from “my(manager)@company.corp”. In one embodiment, the address resolver 140 looks-up a query associated with the alias, executes the query on the enterprise information system 150 and receives the email address of the manager 170, for example “thomas@company.org”. The address resolver 140 redirects the email message by sending the email message to “thomas@company.org” via the email server 130 using proprietary or standard protocols such as SMTP.

The email server 130 proceeds then as with a standard email address and delivers the email message via manager's computer 160 to the manager 170 using proprietary or standard protocols.

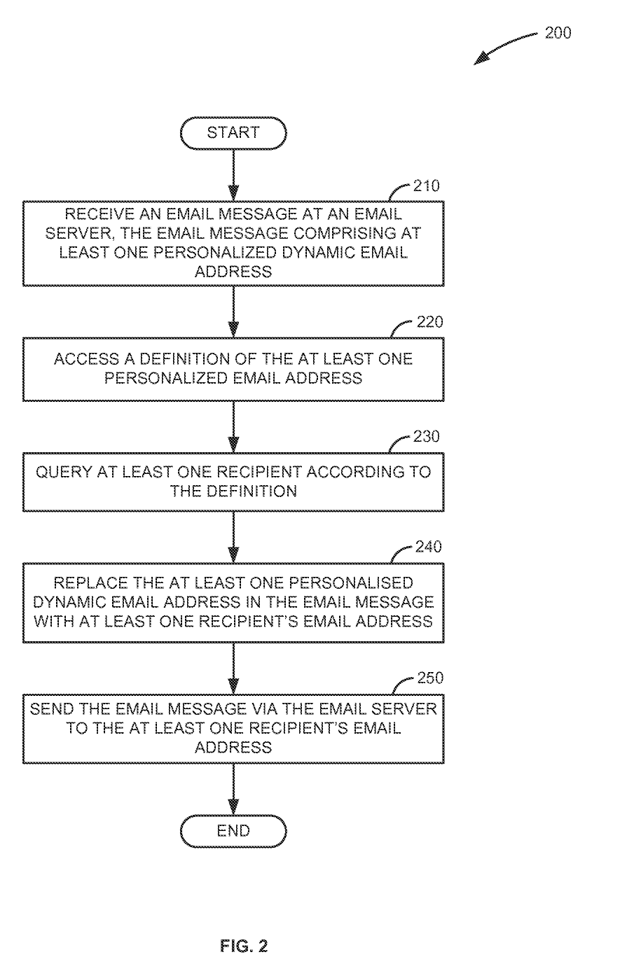

FIG. 2 is a flow diagram illustrating an embodiment of a method 200 for personalized dynamic email addresses in enterprise environments. At block 210, an email message is received at an email server. The email message includes personalized dynamic email addresses. In one embodiment, the personalized dynamic email addresses are predefined. In one embodiment, company administrators and employees define personalized dynamic email addresses by means of a web frontend application or another software application.

The format of the personalized dynamic email addresses may depend on the implementation. In one embodiment, the format may be such as the one presented in relation to FIG. 1, for example “my(manager)@company.corp”. “my” is the email address of an address resolver, for example the address resolver 140 (FIG. 1). In other embodiments, other valid names can be used to address the address resolver, for example “resolver”. Parentheses formally indicate that the enclosed text within the parentheses is a comment, according to the common standard for emails RFC 5322. In one embodiment, the comment may be used to enclose an alias as described further. For example, “manager” is an alias, which identifies a query to dynamically retrieve recipient(s) of the email message. The query is intended to translate the personalized dynamic email address into an exact email address, such as “frank@company.corp”. “@” is the typical delimiter in email addresses and “company.corp” is an example domain name.

Alternatives to the discussed above format of the personalized dynamic email addresses may exist. In one embodiment, an alias may be defined to include dynamic components. For example, if an internal system needs to send an email notification to the manager of a certain employee, the alias may be defined such as “manager-of-?”, where “?” stands for an email alias of an employee. In such case, an email to “my(manager-of-frank)@company.corp” may be transformed to the email address of the manager of the employee having email address “frank@company.corp”.

Turning back to FIG. 2, at block 220, a definition of the personalized email addresses is accessed. In one embodiment the personalized dynamic email addresses may include the address of an address resolver component, such as “my” or “resolver” discussed above.

Then, at block 230, a data storage is queried to find at least one recipient according to the definition. In one embodiment, the personalized dynamic email addresses may include an alias identifying a query to dynamically retrieve the at least one recipient. The query may be formulated in a standard query language such as Structured Query Language (SQL), and the enterprise information system, such as enterprise information system 150 (FIG. 1), may provide an interface for such queries.

TABLE 1

| NAME | ID | EMAIL | MANAGER | STUDENT | LOCATION | SUPERVISOR |
|---|---|---|---|---|---|---|
| Thomas | 1000 | thomas@company.corp | ? | 0 | DA | ? |
| Frank | 1001 | frank@company.corp | 1000 | 0 | KA | ? |
| Anirban | 1002 | anirban@company.corp | ? | 0 | KA | ? |
| Nina | 1003 | nina@company.corp | 1002 | 0 | KA | ? |
| Christoph | 1004 | christoph@company.corp | 1002 | 0 | KA | ? |
| Tom | 1005 | tom@company.corp | 1002 | 0 | KA | ? |
| Dennis | 1006 | dennis@company.corp | ? | 1 | KA | 1001 |

Table 1 shows an exemplary data table within an enterprise information system (EIS), such as enterprise information system 150 (FIG. 1). Table 1 is simplified, this means that either the EIS may provide such simplified tables via database views, or an address resolver, such as the address resolver 140 (FIG. 1), may need to use more complex queries building on the original data tables in the EIS. Typically, the tables contain data, which may be accessible for all employees via a corporate address book. The column NAME contains the name of an employee, the ID is an employee identifier, and EMAIL is the email address of the employee described in the row. The column MANGER contains the ID of the manager of the employee, and the column SUPERVISOR contains an optional supervisor, typically if the employee is a student. The column STUDENT indicates if the person is a student, and the column LOCATION indicates the location of an employee. There may be many more columns describing an employee, and there may also be references to other tables.

At block 240, the personalized dynamic email addresses are replaced in the email message with at least one recipient's email address.

At block 250, the email message is sent via the email server to the at least one recipient's email address.

In one embodiment, the email server uses standard protocols for communication. In other embodiments, the email server uses proprietary protocols for communication, specific for the organization implementing the personalized dynamic email addresses.

Typically, a sender does not know to whom an email message is delivered if sent to a personalized dynamic email address. This may be necessary as senders may need to know whom to contact for a follow-up or to document to which person an email message has been delivered. In one embodiment, confirmation to a sender of a delivery of an email message with a personalized dynamic email addresses is implemented. In one embodiment, the address resolver might be configured to include the sender of an email message in the “CC” or “BCC” field of an email message, which is redirected. In another embodiment, the address resolver might be configured to send a delivery report to the sender of an email message. In yet another embodiment, delivered email messages (or their metadata) may be logged, and the history may be made available via an application server to senders of email messages.

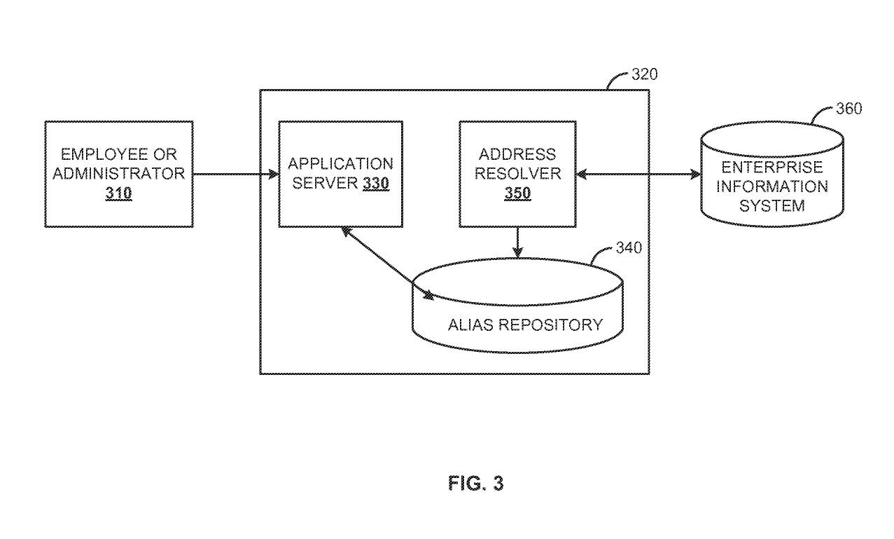

FIG. 3 is a block diagram illustrating a management system 320 for personalized dynamic email addresses in enterprise environments. The management system 320 for personalized dynamic email addresses includes an alias repository 340 containing queries used to translate an alias to one or several email addresses. The alias repository 340 may be a database but may also be some other means of data storage, such as a structured or a flat file, for example, Comma Separated Value (CSV) or Extensible Markup Language (XML) file. The alias repository 340 is intended to map aliases to queries, and it also contains information regarding the creator of a mapping. Table 2 contains exemplary content of an alias repository:

TABLE 2

| ALIAS | CREATOR | QUERY |
|---|---|---|
| manager | | SELECT t2.EMAIL FROM EMPLOYEES t1, EMPLOYEES t2 |
| | | WHERE t1.EMAIL=‘<SENDER>’ AND t1.MANAGER=t2.ID; |
| teamcolleagues | | SELECT t2.EMAIL FROM EMPLOYEES t1, EMPLOYEES t2 |
| | | WHERE t1.EMAIL=‘<SENDER>’ AND t2.MANAGER=t1.MANAGER |
| | | AND t1.EMAIL< >t2.EMAIL AND t2.STUDENT=0; |
| students | | SELECT t2.EMAIL FROM EMPLOYEES t1, EMPLOYEES t2 |
| | | WHERE t1.EMAIL=‘<SENDER>’ AND t2.SUPERVISOR=t1.ID; |
| location | | SELECT t2.EMAIL FROM EMPLOYEES t1, EMPLOYEES t2 |
| | | WHERE t1.EMAIL=‘<SENDER>’ AND t2.LOCATION=t1.LOCATION |
| | | AND t1.EMAIL< >t2.EMAIL; |
| managerlocation | 1001 | SELECT t3.EMAIL FROM EMPLOYEES t1, EMPLOYEES t2, EMPLOYEES t3 |
| | | WHERE t1.ID=‘1001’ AND t1.MANAGER=t2.ID |
| | | AND t2.LOCATION=t3.LOCATION; |

The column “ALIAS” contains email alias of a personalized dynamic email address. For example, alias “manager” may refer to the manager of the sender of an email; alias “teamcolleagues” may refer to all direct colleagues of the sender of an email, i.e. all people having the same manager, which are not students; alias “students” may refer to all students that have the sender of the email as a supervisor; alias “location” may refer to all employees at the same location as the sender of the email; and alias “managerlocation” may refer to all employees at the same location as the manager of the employee with ID 1001 (from the column “CREATOR”). The column “CREATOR” indicates which employee has created an individual personalized mapping, if empty, the mapping may be public. The column “QUERY” contains the query corresponding to the alias. Within the query, angle brackets may refer to fields from the email to be processed, for example, “<SENDER>” stands for the sender of an email. All these queries assume the existence of a table “EMPLOYEES” in the enterprise information system such as Table 1.

When executing the queries presented in Table 2 on the data in the Table 1, the results may be:

frank@company.corp sends an email to my(manager)@company.corp
Recipient: thomas@company.corp

nina@company.corp sends an email to my(teamcolleagues)@company.corp
Recipients: christoph@company.corp, tom@company.corp

frank@company.corp sends an email to my(students)@company.corp
Recipient: dennis@company.corp

tom@company.corp sends an email to my(location)@company.corp
Recipients: frank@company.corp, nina@company.corp, anirban@company.corp, christoph@company.corp, dennis@company.corp

frank@company.corp sends an email to my(managerlocation)@company.corp
Recipient: thomas@company.corp

An address resolver 350 gets the query from the alias repository 340 and executes it on an enterprise information system 360. An application server 330 within the management system 320 for personalized dynamic email addresses in enterprise environments provides an application, for example a web application (not shown), which allows adding, deleting, executing, and changing entries in the alias repository 340. Such an application may be used by a company administrator 310 to maintain personalized dynamic email addresses to be used by employees. In one embodiment, employees may also maintain further individual personalized email addresses using such an application provided by the application server 330. The application may handle pure SQL queries or may provide some visual means or wizard to maintain the queries. Because the application server 330 may also execute queries, this functionality may be used for testing purposes or to browse potential recipients of an email to confirm that a certain alias is correct.

The described embodiments may utilize alternative email address formats for personalized dynamic email addresses. The format “my(manager)@company.corp”, described above, which has an alias “manager” in a comment included in parentheses, is advantageous, because standard mail clients may be used without modifications. However RFC 5322 indeed recommends not using comments in address fields, because some legacy implementations may remove comments. Because the current embodiments are meant to be implemented within companies, an environment without such legacy systems may be expected. Some current email programs do not treat comments correctly. Therefore the following two alternatives may be implemented. Instead of using comments in email addresses, for example, “my(manager)@company.corp”, the name field as defined in RFC 5322 may be used alternatively: “manager <my@company.corp>”. The address “my@company.corp” may be the address from the address resolver component, which then uses the name (instead of a comment) as the alias to resolve the final recipient(s) of the email. This variation may also be used without the need to change any existing email clients or servers within a company.

Instead of comments or the name field (as proposed in the previous paragraph), the usage of different identifiers in email address may be used, with slight modifications of the affected systems. An example may be an email address like “!manger@company.corp”, where the exclamation mark identifies that the text enclosed by “!” and “@” is an alias, which needs to be treated by the address resolver component. “!” may be any valid character which is normally not used in company email addresses. However, this or similar embodiments require slight changes in the mail servers as all such addresses need to be forwarded to the address resolver component.

Different companies and different users may have different preferences how details of the current embodiments may be implemented. Therefore, variations may be realized with and may be configured for a whole organization or individually by the users (employees). One aspect which may be configured differently according to the specificities of the organizations is a feature if a recipient of an email should know that a mail was sent via a dynamic email address or not. The address resolver could keep the original “To” field of the message header (e.g., “my(manager)@company.corp”) and redirect the mail to another address (e.g., “thomas@company.corp”), or the address resolver could just change the “To” field of the email (e.g., from “my(manager)@company.corp” to “thomas@company.corp”). The first alternative gives the recipient of the email the knowledge that a dynamic email address was used and the recipient may better understand why the salutation in the email may not be personalized. In other configurations, other means may be used to indicate that an email is delivered using a personalized dynamic email address. This includes prefixes in the message subject or textual notifications in the email body (for example: “This message was originally sent to my(manager)@company.corp.”).

In one embodiment, the alias translation may be done prior to sending the email message, within the email client of the sender. Such alternative may be used in addition or as an exclusive embodiment. By using a plug-in for a client program, a sender may translate a dynamic email address to a real address on her or his computer. This allows the usage of personalized salutations within the email body and provides control to which recipient(s) an email will be delivered. In this embodiment, the plug-in in the email client program on the sender's computer may directly access the address resolver component via a dedicated interface, for example, a Web Service or a Representational State Transfer (REST) interface, and may translate a dynamic email address, such as “my(manager)@company.corp”, to a real email address (e.g., “thomas@company.corp”).

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments may include remote procedure calls being used to implement one or more of these components across a distributed programming environment. For example, a logic level may reside on a first computer system that is located remotely from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of non-transitory computer readable storage media include, but are not limited to: magnetic media, such as hard disks, floppy disks, and magnetic tape; optical media such as CD-ROMs, DVDs and holographic devices; magneto-optical media: and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

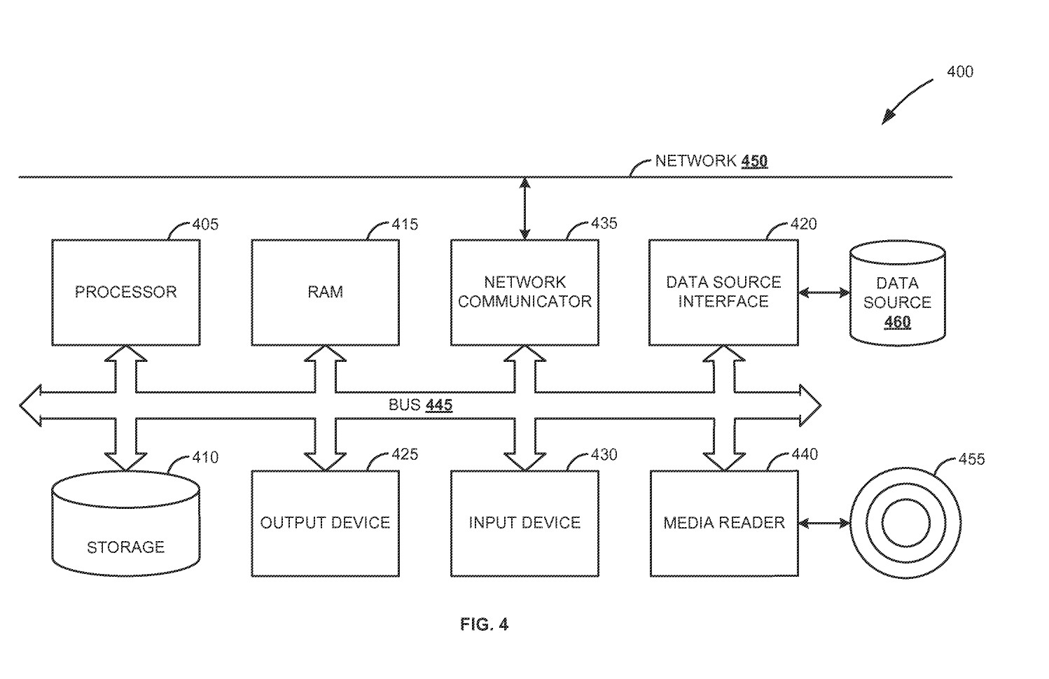

FIG. 4 is a block diagram of an exemplary computer system 400. The computer system 400 includes a processor 405 that executes software instructions or code stored on a computer readable storage medium 455 to perform the above-illustrated methods of the invention. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment of the invention, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 460. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g. data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method for personalized dynamic email addresses, the method comprising:
receiving an email message at an email server, the email message comprising at least one personalized dynamic email address;
accessing a definition of the at least one personalized dynamic email address;
querying a data storage to find at least one recipient according to the definition;
replacing the at least one personalized dynamic email address in the email message with at least one recipient's email address; and
sending the email message via the email server to the at least one recipient's email address.

2. The method of claim 1, wherein the at least one personalized email address is predefined.

3. The method of claim 1, wherein the at least one personalized email address comprises an address of an address resolver component.

4. The method of claim 1, wherein the at least one personalized email address comprises an alias identifying a query to dynamically retrieve the at least one recipient.

5. The method of claim 1, wherein the email server uses standard protocols for communication.

6. The method of claim 1, further comprising confirming a delivery to a sender of the email message with the at least one personalized dynamic email address.

7. A computer system for personalized dynamic email addresses, comprising:
a processor; and
a memory in communication with the processor, the memory storing instructions related to:
an email server to receive an email message, the email message comprising at least one personalized dynamic email address; and
an address resolver to:
receive the email message from the email server;
query a data storage to find at least one recipient according to a definition of the at least one personalized dynamic email address;
replace the at least one personalized dynamic email address in the email message with at least one recipient's email address; and
redirect the email message to the at least one recipient's email address via the email server.

8. The system of claim 7, wherein the at least one personalized email address is predefined.

9. The system of claim 8, further comprising a web interface to predefine the at least one personalized email address.

10. The system of claim 7, wherein the at least one personalized email address comprises an address of an address resolver component to direct the email message to the address resolver.

11. The system of claim 7, wherein the at least one personalized email address comprises an alias used by the address resolver to identify a query to dynamically retrieve the at least one recipient.

12. The system of claim 11, wherein the query is executed on an enterprise information system.

13. The system of claim 11, further comprising an alias repository to preserve queries to translate the alias to the at least one recipient.

14. The system of claim 13, further comprising an application server providing a web application to manage content of the alias repository.

15. An article of manufacture including a non-transitory computer readable storage medium to tangibly store instructions, which when executed by a computer, cause the computer to:
receive an email message at an email server, the email message comprising at least one personalized dynamic email address;
access a definition of the at least one personalized dynamic email address;
query a data storage to find at least one recipient according to the definition;
replace the at least one personalized dynamic email address in the email message with at least one recipient's email address; and
send the email message via the email server to the at least one recipient's email address.

16. The article of manufacture of claim 15, wherein the at least one personalized email address is predefined.

17. The article of manufacture of claim 15, the at least one personalized email address comprises an address of an address resolver component.

18. The article of manufacture of claim 15, wherein the at least one personalized email address comprises an alias identifying a query to dynamically retrieve the at least one recipient.

19. The article of manufacture of claim 15, wherein the email server uses standard protocols for communication.

20. The article of manufacture of claim 15, further comprising instructions, which when executed by the computer, cause the computer to confirm a delivery to a sender of the email message with the at least one personalized dynamic email address.
